(19) United States
(12) Patent Application Publication
(10) Pub. No.: US 2005/0144179 A1
(43) Pub. Date: Jun. 30, 2005

(54) Method and apparatus for document-analysis, and computer product

(75) Inventors: Koji Maruhashi, Kawasaki (JP); Yoshio Nakao, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/856,085

(22) Filed: May 28, 2004

(30) Foreign Application Priority Data
Dec. 25, 2003 (JP) 2003-430026

(51) Int. Cl. G06F 7/00

(52) U.S. Cl. 707/100

(57) ABSTRACT

In a device, a generating unit generates the document-information sets corresponding to each joint-author from the relevant-document information set, an analysis-result storing unit stores the result of the user's analyzing the document-information sets corresponding to each joint-author in the analysis-result DB as a topic, an analysis-result integrating unit integrates the joint author's topics stored in the analysis-result DB and displays the topics integrated as the integrated analysis-result screen. Appropriate screens are displayed to support selection of the target for the analysis using the document-information sets that the generating unit generates corresponding to each joint-author.

### BACKGROUND OF THE INVENTION

1) Field of the Invention

The present invention relates to a technology for analyzing a relevant-document information set, which is a set of information about relevant documents.

2) Description of the Related Art

One approach in retrieving a set of documents that are related to each other (hereinafter, relevant-document set) from treatises or a vast number of technical literatures is to use a keyword, and this approach is widely used in various fields.

For example, the most famous database of abstracts of the medicine-related documents and the biology-related documents, MEDLINE, is an online service provided by the US National Library of Medicine (NLM). PubMed, which is a document retrieval system provided by a division of NLM, National Center for Biotechnology Information (NCBI), is used to retrieve documents from MEDLINE. More information can be obtained from the web site of NCBI “URL: http://www.ncbi.nlm.nih.gov/” and the web site of PudMed “URL: http://www.ncbi.nlm.nih.gov/entrez/query.fcgi”. The web site of PudMed was confirmed to be functional on Dec. 12, 2003.

When a keyword search is run by name of a gene or name of a life phenomenon using PubMed, a set of the biology-related documents, which is related to the keyword, can be acquired. Therefore, PubMed is popular among researchers in biology now.

After acquiring the relevant-document set, the researchers need to analyze the relevant-document set closely to acquire the required knowledge from the contents of the documents. When such analysis is made based on the background leaning-scheme and the background technology-scheme, the relationship between the contents of each document of the treatises and the technical literature become clears and the desired knowledge can be acquired more easily.

There is also a tendency that the same author or the same group of authors writes scientific literature having similar contents. Therefore, the retrieving can be performed more efficiently if the document set is divided based on the authors.

Generally, the databases of the treatises and the technical information are configured to run a keyword search by journal that provides the document, author, or the like. For example, in MEDLINE, the information, such as a title, a journal that provides a document, a publication date, an author of the document, are accompanied with the abstract of the document, and can be acquired using PubMed. In such an environment, by running a keyword search by name of an author using the conventional document-retrieval, the document set can be easily divided into the document subsets based on the author.

The Japanese Patent Application Laid-Open No. 2003-167890 discloses a technology that automatically extracts a characteristic term relevant to the author, and constructs a database of a person and a term based on the characteristic term relevant to the author. This technology detects the probable researcher who satisfies the purpose of the analysis, acquires the document set, and performs the analysis, even when a database, which is configured to run a keyword search by name of an author of a document, does not exist.

However, even if the treatises and the technical information are divided into the document subset based on the author, the problem is that analyzing the set of the documents of the author who has many literary works is difficult. For example, when a keyword search is run by name of an author using PebMed, and the author has many literary works, the document set includes more than a hundred documents, and it is difficult to closely analyze the document set as it is.

In this case, if the analysis is made by further dividing the set of the author's documents into the subsets according to the joint author or the joint author's group, the analysis can be performed easily. However, in the analysis of document subsets, there occurs a problem that it is difficult to grasp the interrelation between the subsets and where the subsets are positioned in the whole.

Moreover, the subsets overlap each other intricately because of the complex relation between joint authors, therefore, analyzing all the subsets one by one is inefficient. Consequently, in the process of analyzing the documents based on the author, the process of finding the document subset that is appropriate to the analysis and the process of analyzing the document subsets need to be performed in flexible order by trying the process and selecting the process.

To perform these processes smoothly, concentrating on a series of operations and considerations, which need to be performed immediately, is required. Therefore, storing the analysis result of the document set divided and ensuring that the analysis result is integrated later is required. In the conventional technologies, the documents of the specific author or the specific author's group can be retrieved and analyzed using the document retrieval system, however, there has not been the document analysis system that holds the analysis result and supports the integration of the partial analysis result. Consequently, it is difficult to satisfy the request of storing the analysis result of the document set divided and ensuring that the analysis result is integrated later.

### SUMMARY OF THE INVENTION

It is an object of the present invention to solve at least the problems in the conventional technology.

A computer program according to an aspect of the present invention is a computer program for analyzing a first information-set, which is a set of information about a document relevant to a subject, the computer program makes a computer execute generating second information-sets, which are sets of document information, from the first set corresponding to each of a plurality of joint authors; and displaying information about the second information-sets.

A computer program according to another aspect of the present invention is a computer program for analyzing a first information-set, which is a set of information about a relevant document, in response to a request from a terminal that a user operates, the computer program makes a computer execute generating a second information-set, which is a set of document information, from the first set corresponding to each of plurality of joint authors; generating data for displaying document information from information of the second set corresponding to each of the joint authors, the document information is displayed on the terminal using the data for displaying the document information; and transmitting the data for displaying the document information to the terminal.

A computer-readable recording medium according to still another aspect of the present invention is a computer program stores the computer program according to the present invention.

A method according to still another aspect of the present invention is a method of analyzing a first information-set, which is a set of information about a document relevant to a subject, comprising generating second information-sets, which are sets of document information, from the first set corresponding to each of a plurality of joint authors; and displaying information about the second information-sets.

A method according to still another aspect of the present invention is a method of analyzing a first information-set, which is a set of information about a relevant document, in response to a request from a terminal that a user operates, comprising generating a second information-set, which is a set of document information, from the first set corresponding to each of plurality of joint authors; generating data for displaying document information from information of the second set corresponding to each of the joint authors, the document information is displayed on the terminal using the data for displaying the document information; and transmitting the data for displaying the document information to the terminal.

A device according to still another aspect of the present invention is a device for analyzing a first information-set, which is a set of information about a document relevant to a subject, comprising: a generating unit that generates second information-sets, which are sets of document information, from the first set corresponding to each of a plurality of joint authors; and a displaying unit that displays information about the second information-sets.

A device according to still another aspect of the present invention is a device for analyzing a first information-set, which is a set of information about a relevant document, in response to a request from a terminal that a user operates, comprising: an integrating unit that generates a second information-set, which is a set of document information, from the first set corresponding to each of plurality of joint authors; a generating unit that generates data for displaying document information from information of the second set corresponding to each of the joint authors, the document information is displayed on the terminal using the data for displaying the document information; and a transmitting unit that transmits the data for displaying the document information to the terminal.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a view for explaining a principle of a document analysis made by a document-analysis apparatus according to an embodiment of the present invention;

FIG. 2 is a block diagram of the document-analysis apparatus according to the embodiment;

FIG. 3 is a view of an example of information that a document-retrieving unit acquires from a document DB;

FIG. 4A is a view of document-information sets that a generating unit generates corresponding to each joint-author;

FIG. 4B is a view of an example in which joint author's names are corresponding to each document ID based on the document-information sets that the generating unit generates corresponding to each joint-author;

FIG. 5A is a view an example 1 of a screen that the generating unit displays to support selecting target for analysis;

FIG. 5B is a view of an example 2 of the screen that the generating unit displays to support selecting the target for the analysis;

FIG. 5C is a view of an example 3 of the screen that the generating unit displays to support selecting the target for the analysis;

FIG. 6A is a view to explain how a user analyzes the document-information sets corresponding to each joint-author;

FIG. 6B is a view of an example of an analysis result stored;

FIG. 7 is a view of an example of an analysis-result DB;

FIG. 8A is a view of an example 1 of a screen on which an analysis-result integrating unit displays an integrated analysis-result;

FIG. 8B is a view of an example 2 of the screen on which the analysis-result integrating unit displays the integrated analysis-result;

FIG. 8C is a view of an example 3 of the screen on which the analysis-result integrating unit displays the integrated analysis-result;

FIG. 8D is a view of an example 4 of the screen on which the analysis-result integrating unit displays the integrated analysis-result;

FIG. 9 is a view of an example of a display screen that an input-output unit outputs;

FIG. 10 is a flowchart of operations of the document-analysis apparatus according to the present embodiment;

FIG. 11 is a flowchart of operations of the generating unit shown in FIG. 2;

FIG. 12 is a flowchart of operations of the analysis-result integrating unit shown in FIG. 2;

FIG. 13 is a schematic diagram of a computer system that executes a document-analysis computer program according to the present embodiment; and

FIG. 14 is a block diagram of a main unit shown in FIG. 13.

### DETAILED DESCRIPTION

Exemplary embodiments of a method and an apparatus for document-analysis, a computer program, and a storage media for storing the computer program, will be explained with reference to the accompanying diagrams.

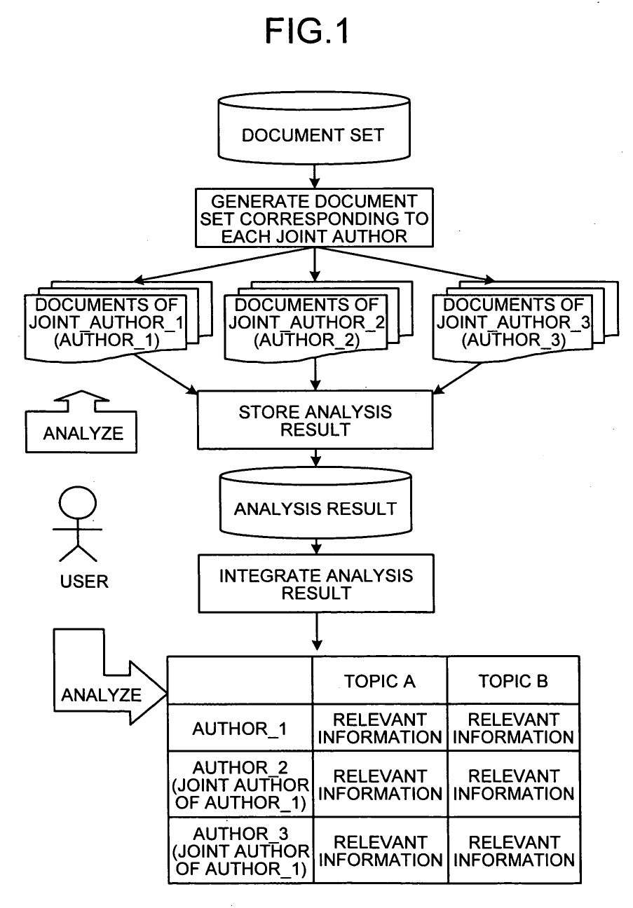

FIG. 1 is a view for explaining a principle of a document analysis made by a document-analysis apparatus according to a present embodiment. The document-analysis apparatus according to the present embodiment generates the document sets corresponding to each author from the relevant-document set.

The documents include a document written by a single author and a collaboration document written by other authors, therefore, a document set corresponding to a joint-author may be a document set corresponding to a single author or a document set corresponding to other authors. Hereinafter, a joint author indicates a single author or a joint author for convenience.

As shown in FIG. 1, a document subset of “JOINT_AUTHOR_{—}1”, a document subset of “JOINT_AUTHOR_{—}2”, and a document subset of “JOINT_AUTHOR_{—}3” are generated corresponding to two authors “AUTHOR_{—}1” and “AUTHOR_{—}2”. The document set of “JOINT_AUTHOR_{—}1” includes a document written by “AUTHOR_{—}1” and a document written by other authors including “AUTHOR_{—}1”. A document set of “JOINT_AUTHOR_{—}2” includes a document written by “AUTHOR_{—}2” and a document written by other authors including “AUTHOR_{—}2”. A document set of “JOINT_AUTHOR_{—}3” includes a collaboration document written by other authors including “AUTHOR_{—}1” and “AUTHOR_{—}2”. Therefore, for example, the collaboration document written by “AUTHOR_{—}1” and “AUTHOR_{—}2” is redundantly included in the document subset of “JOINT_AUTHOR_{—}1”the document subset of “JOINT_AUTHOR_{—}2”, and the document subset of “JOINT_AUTHOR_{—}3”.

Similarly, if there are three authors of “AUTHOR_{—}1”, “AUTHOR_{—}2”, and “AUTHOR_{—}3”, there are the following document sets:
a document set that includes a document written by “AUTHOR_{—}1” and a document written by other authors including “AUTHOR_{—}1”;
a document set that includes a document written by “AUTHOR_{—}2” and a document written by other authors including “AUTHOR_{—}2”;
a document set that includes a document written by “AUTHOR_{—}3” and a document written by other authors including “AUTHOR_{—}3”;
a document set that includes a document written by other authors including “AUTHOR_{—}1” and “AUTHOR_{—}2”;
a document set that includes a document written by other authors including “AUTHOR_{—}2” and “AUTHOR_{—}3”;
a document set that includes a document written by other authors including “AUTHOR_{—}1” and “AUTHOR_{—}3”; and
a document set that includes a document written by other authors including the “AUTHOR_{—}1” “AUTHOR_{—}2”, and “AUTHOR_{—}3”.

Then, the document-analysis apparatus according to the present embodiment presents information about the document sets, which are generated corresponding to each joint-author, to the user, and adds a result, which the user inputs after analyzing the information presented, to the document sets corresponding to each joint-author.

For example, if the user analyzes the information and gets the result that the document set of “JOINT_AUTHOR_{—}1” is a document set corresponding to TOPIC_A, the document-analysis apparatus adds TOPIC_A to the document set of “JOINT_AUTHOR_{—}1” (“AUTHOR_{—}1”) as an analysis result. If the user analyzes the information and gets the result that the document set of “JOINT_AUTHOR_{—}3” is to a document set corresponding to TOPIC_B, the document-analysis apparatus adds TOPIC_B to the document set of “JOINT_AUTHOR 3” (“AUTHOR_{—}1” and “AUTHOR_{—}2”) as an analysis result.

Subsequently, the document-analysis apparatus stores the analysis result, which is added to each of the document sets corresponding to each joint-author, in a database, integrates the analysis result stored corresponding to the author and the topic, and shows the analysis result integrated (which may be called an “integrated analysis-result”). For example, when TOPIC_A is a result of analyzing the document set of “JOINT_AUTHOR_{—}1”, the document-analysis apparatus presents the relevant information that indicates the relation between TOPIC_A and either “AUTHOR_{—}1” or “JOINT_AUTHOR_{—}1” to the user.

In this manner, the document-analysis apparatus generates the document sets, corresponding to each joint-author, from the relevant-document set by determining whether the document are written by at least a common author, and presents the information about the document sets, which are generated corresponding to each joint-author, to the user. The documents written by the common author tend to include the common topic, so that the user can find the document that includes a topic easily.

Moreover, the analysis of a series of documents is made easily in general, therefore, the analysis can be made efficiently. Most of the contents reported in a series of the documents relate to each other, therefore, the contents relating to each other can be extracted at a time.

Moreover, the document-analysis apparatus extracts the analysis result, which relates to at least an author that the user specifies, from the analysis result, which the user gets though the analysis of the document sets corresponding to each joint-author, and presents the analysis result in order. Therefore, the document-analysis apparatus can support integrating the analysis result as an attribute of the author or the authors.

Consequently, the user can see the result of analyzing the document sets corresponding to each joint-author from a macro viewpoint, and determine the relevance, which is hard to determine in the analysis of the document sets corresponding to each joint-author, of the topic.

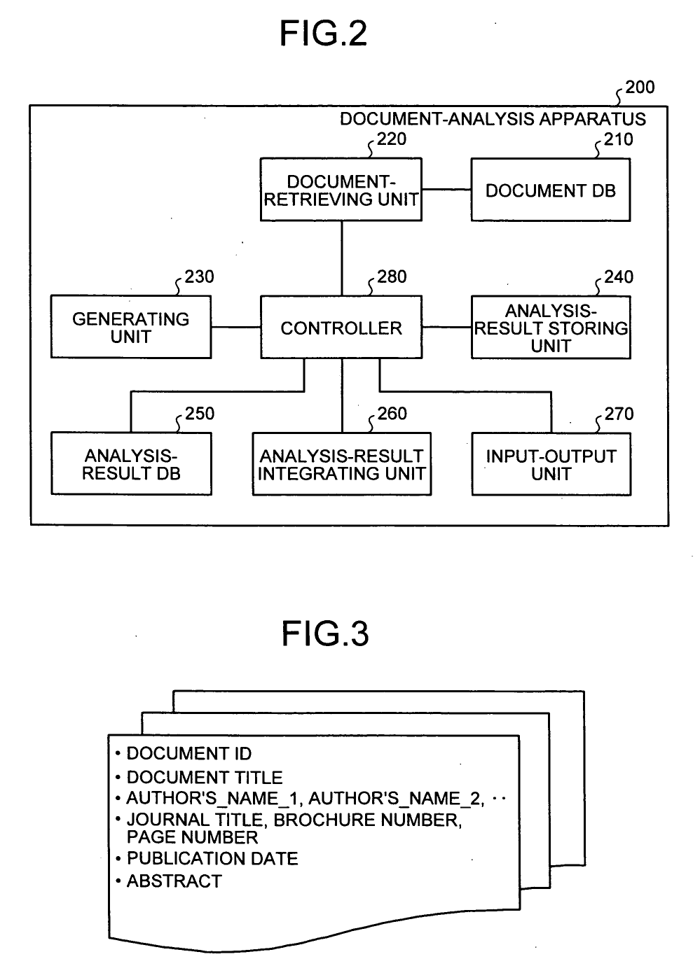

FIG. 2 is a block diagram of a document-analysis apparatus 200. The document-analysis apparatus 200 includes a document DB 210, a document-retrieving unit 220, a generating unit 230, an analysis-result storing unit 240, an analysis-result DB 250, an analysis-result integrating unit 260, an input-output unit 270, and a controller 280.

The document DB 210 stores documents such as treatises and technical information. For example, the user can retrieve the relevant documents with a keyword using the document DB 210.

The document-retrieving unit 220 searches the document DB 210 in response to the search request from the user, and acquires the information about the relevant document from the document DB 210. As shown in FIG. 3, the exemplary information that the document-retrieving unit 220 acquires from the document DB 210 are a document ID, a document title, an author's name, information about a journal including a document, such as a journal title, a publication date, and an abstract.

The generating unit 230 generates the document-information sets, corresponding to each joint-author, from the relevant-document information set, which the document-retrieving unit 220 acquires from the document DB 210, and stores the information about the document-information sets, corresponding to each joint-author, in the analysis-result DB 250. The generating unit 230 generates the document-information sets, corresponding to each joint-author, by determining whether the document is written by at lease a common author.

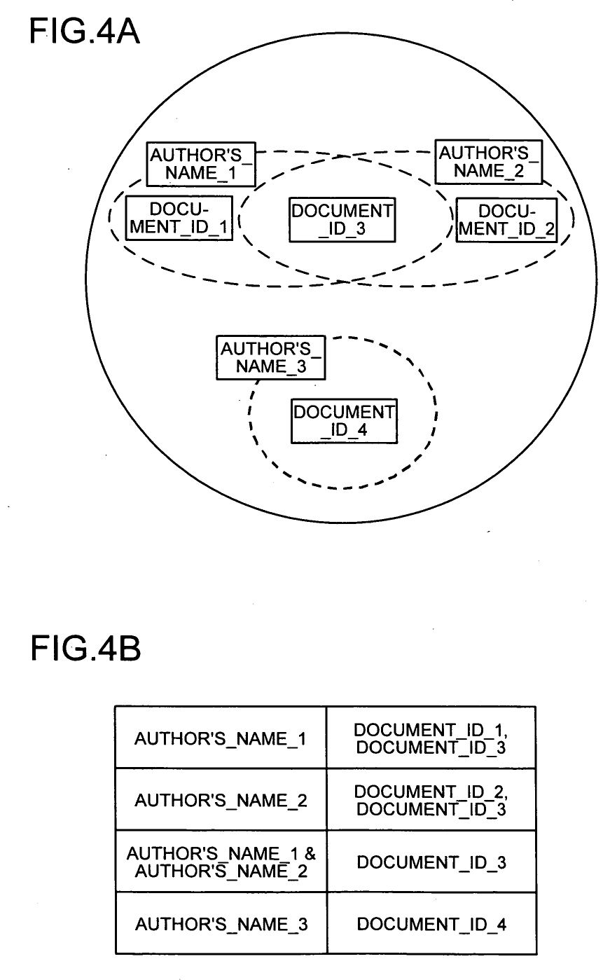

FIG. 4A is a view of document-information sets that the generating unit 230 generates corresponding to each joint-author. A relevant-document information set, which the document-retrieving unit 220 acquires from the document DB 210, is shown inside a solid circle while a document-information set, corresponding to a specific joint-author, is shown inside dashed ellipses.

For example, the document-information set corresponding to a joint author whose name is “AUTHOR'S_NAME_{—}1” includes information about a document whose document ID is “DOCUMENT_ID_{—}1” and “DOCUMENT_ID_{—}3”. In other words, “AUTHOR'S_NAME_{—}1” indicates a name of an author of a document whose document ID is “DOCUMENT_ID_{—}1” or “DOCUMENT_ID_{—}3”.

Similarly, the document-information set corresponding to a joint author whose name is “AUTHOR'S_NAME_{—}2” includes information about a document whose document ID is “DOCUMENT_ID_{—}2” and “DOCUMENT_ID_{—}3”. In other words, “AUTHOR'S_NAME_{—}2” indicates a name of an author of a document whose document ID is “DOCUMENT_ID_{—}2” or “DOCUMENT_ID_{—}3”.

A document whose document ID is “DOCUMENT_ID_{—}3” is a collaboration document of an author whose name is “AUTHOR'S_NAME_{—}1” and an author whose name is “AUTHOR'S_NAME_{—}2”, therefore, the information about the document whose document ID is “DOCUMENT_ID 3” is also included in the document-information set corresponding to a joint author whose name is “AUTHOR'S_NAME_{—}1&AUTHOR'S_NAME 2”.

FIG. 4B is an example of a table that contains the joint author's names, which is corresponding to each document ID based on the document-information sets, which the generating unit 230 generates corresponding to each joint-author. It can be confirmed fro this table that an author of a document whose-document ID is “DOCUMENT_ID_{—}1” or “DOCUMENT_ID_{—}3” has a name “AUTHOR'S_NAME_{—}1”, and a joint author of a document whose document ID is “DOCUMENT_ID_{—}3” includes an author whose name is “AUTHOR'S_NAME_{—}1” and an author whose name is “AUTHOR'S_NAME_{—}2”.

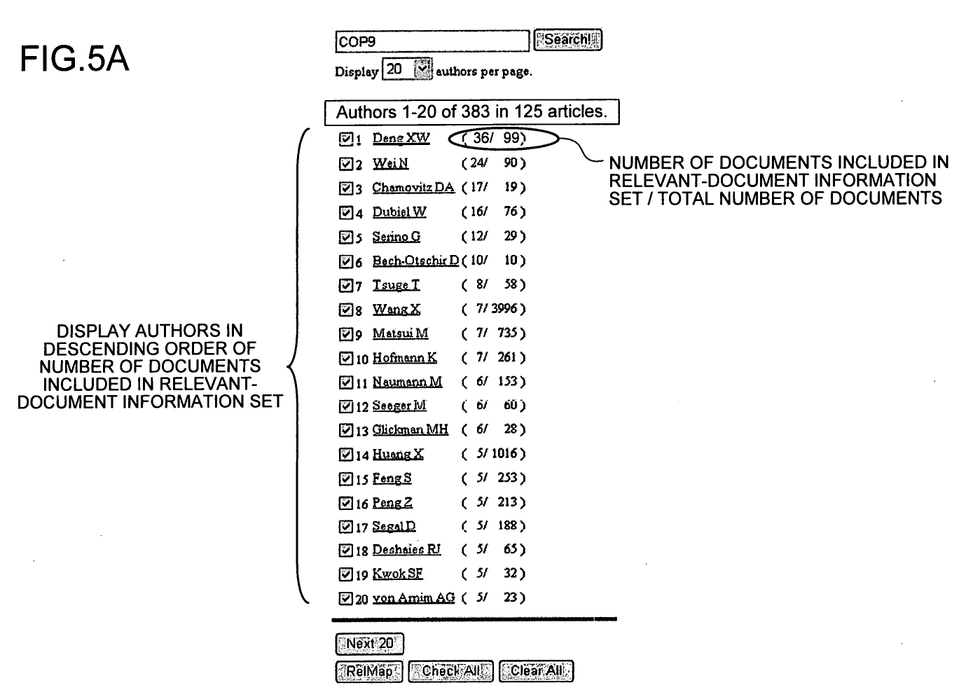

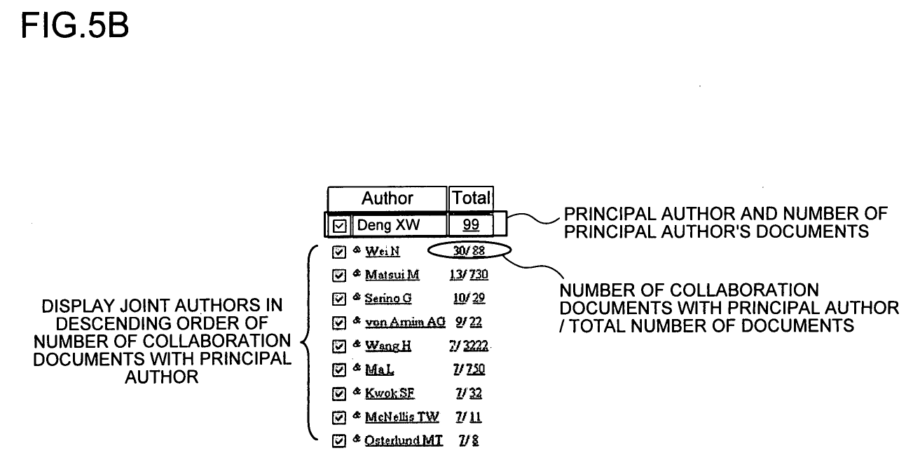

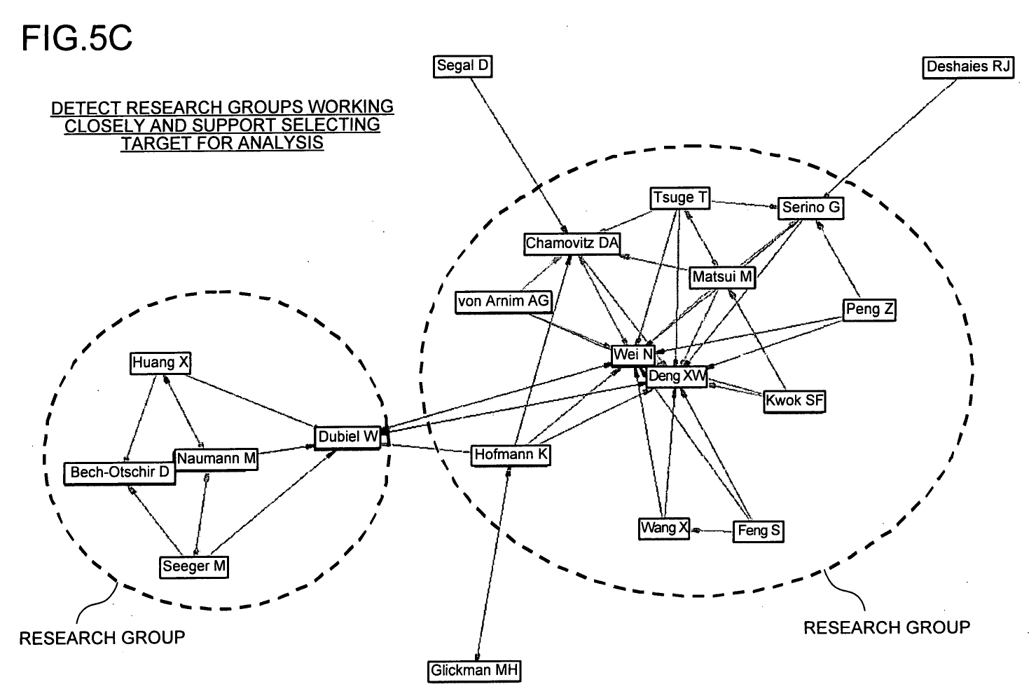

When the user analyzes the documents, the generating unit 230 provides the information, which supports the user's selecting the target for the analysis, based on the document-information set corresponding to each joint-author The screens that the generating unit 230 displays to support selection of the target for the analysis are shown in FIGS. 5A to 5C.

As shown in FIG. 5A, the names of authors who appear in the documents included in the relevant-document information set, which the document-retrieving unit 220 acquires from the document DB 210, are displayed in descending order of times the author appears. The number of times the author appears and the total number of the documents are displayed with the name of the author. The total number of the documents indicates the number of the documents that is in the document DB 210 and the author appears in.

FIG. 5A is an example of a screen when the document DB 210 is searched using a keyword “COP9”, and a set of the “COP9”-relevant document information is acquired. In the set of the “COP9”-relevant document information, the number of the documents that includes the author “Deng XW” is the largest, the number is “36”, and the total number of the documents is “99.” Consequently, the user can preferentially start the analysis with the documents of the author “Deng XW”, who is the most probable.

As shown in FIG. 5B, the joint authors of the principal author, who is centered in the analysis, are displayed with the number of the collaboration documents included in the document DB 210 and the total number of the documents included in the document DB 210 in descending order of the number of the collaboration documents. The joint author who has the largest number of the collaboration documents with the principal author “Deng XW” is “Wei N”, the number of the collaboration document is “30”, and the total number of the documents is “88”. Consequently, the user can preferentially start the analysis with the documents of “Wei N”, who is the most probable joint-author of “Deng XW”, using this screen.

As shown in FIG. 5C, a network diagram, which indicates the relation among the authors who have the collaboration documents, is displayed. In the network diagram, a node indicates an author who has many collaboration documents and a line shows whether an author has the common collaboration-document with another author. Therefore, the user can detect the research group composed of the authors who work closely. For example, the user can infer from the network diagram that “Deng XW”, “Matsui M”, “Wei N”, and others form a reseach group while “Nauman M”, “Bech-Otschir D”, “Huang X”, and others form another research group.

The analysis-result storing unit 240 stores the analysis result, which the user inputs after analyzing the document-information sets corresponding to each joint-author, in the analysis-result DB 250.

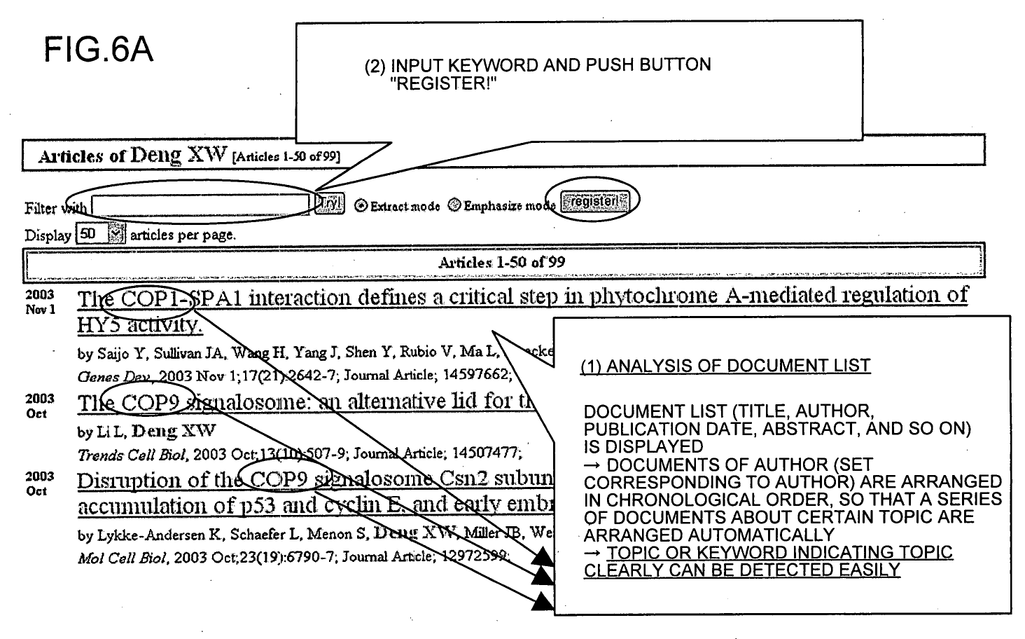

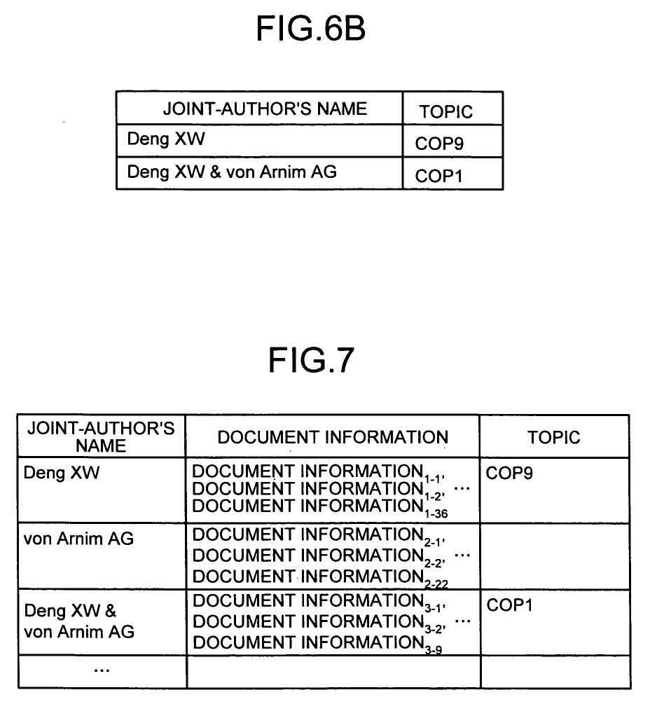

A screen, shown in FIG. 6A, displays a document list when the user selects “Deng XW” as a principal author in the screen shown in FIG. 5A. This screen displays the list of the documents that includes “Deng XW” as an author in chronological order, therefore, a series of the documents about a certain topic are listed automatically.

Consequently, the user can detect a topic of the document that includes “Deng XW” as an author, or a keyword that indicates the topic clearly (1). Then, the user inputs the keyword, which indicates the topic detected, in the input space provided (2).

In this manner, the user can store the analysis result of the document-information sets corresponding to each joint-author in the analysis-result DB 250 as a topic. A view, shown in FIG. 6B, is an example of the analysis result stored. In the table shown in FIG. 6B, “COP9” is stored as a analysis result of the document-information set corresponding to the joint author whose name is “Deng XW”, and “COP1” is stored as a analysis result of document-information set corresponding to the joint author whose name is “Deng XW & von Arnim AG”, which indicates “Deng XW” and “von Arnim AG” are included as a joint author.

Although the user inputs the analysis result of the document-information set corresponding to each joint-author based on the information of the document list in this case, the analysis-result storing unit 240 may analyze the information about the document in the generation list, show the user the terms that appear frequently in descending order of frequency as a topic candidate, and the user may select the topic as a analysis result from the topic candidates.

The analysis-result DB 250 is a database that stores information about the document-information set corresponding to each joint-author. FIG. 7 is a view of an example of the analysis-result DB 250. As shown in FIG. 7, the analysis-result DB 250 stores the joint-author's name, the document information, and the topic corresponding to each of the document-information sets, which are corresponding to each joint-author.

For example, the document-information set corresponding to the joint author “Deng XW” includes 36 pieces of document information, document information ₁₋₁ to document information ₁₋₃₆, and the topic “COP9”. The document-information set corresponding to the joint author “Deng XW & von Arnim AG” includes 9 document informations, document information 3-1 to document information 3-9, and the topic “COP1”.

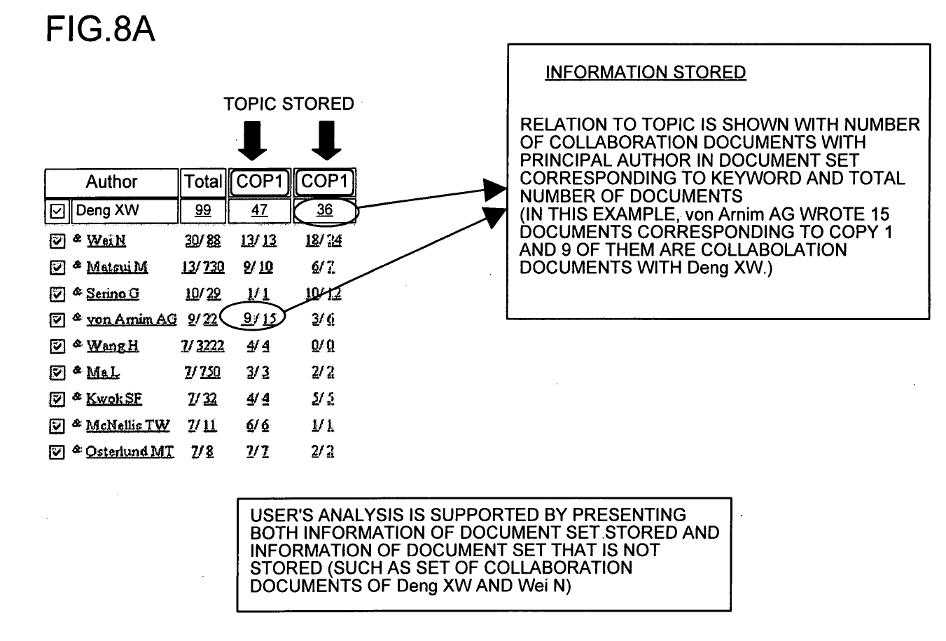

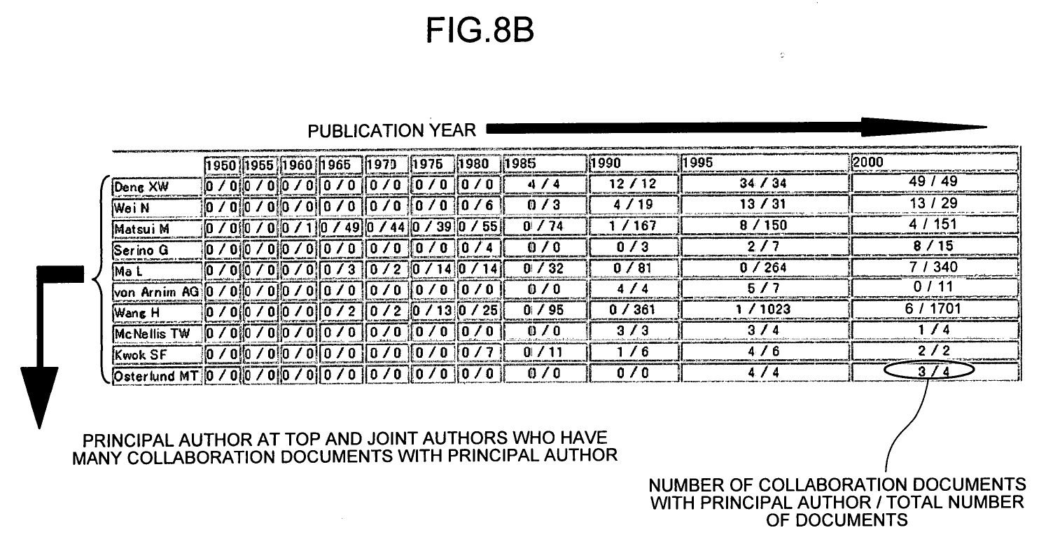

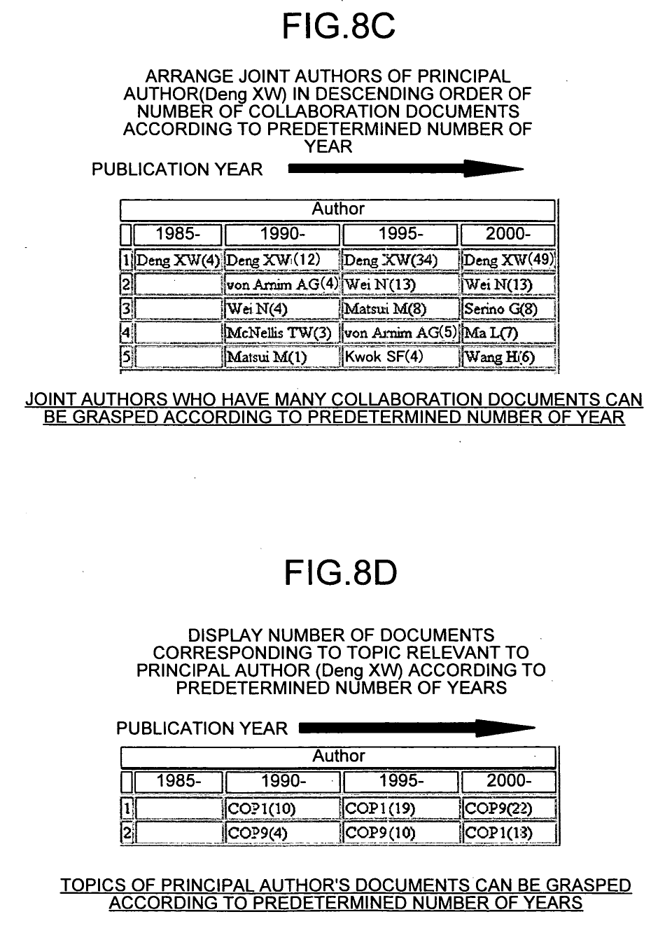

The analysis-result integrating unit 260 integrates the analysis result stored in the analysis-result DB 250 and displays the integrated analysis-result corresponding to the author specified by the user or the topic specifies by the user. Examples 1 to 4 of a screen, on which the analysis-result integrating unit 260 displays the integrated analysis-result, are shown in FIGS. 8A to 8D. This screen may be called an “integrated analysis-result screen”.

The integrated analysis-result screen, shown in FIG. 8A, is displayed by the analysis-result integrating unit 260 using the analysis-result DB 250 shown in FIG. 7 when the user specifies the author's name “Deng XW”. As shown in FIG. 8A, the integrated analysis-result screen displays the names of the authors, who have the collaboration document with “Deng XW”, with the number of the collaboration documents about the topic relevant to “Deng XW” and the total number of the documents.

As shown in FIG. 7, in the analysis-result DB 250, the topic “COP9” is stored corresponding to the author's name “Deng XW” while the topic “COP1” is not stored corresponding to the author's name “Deng XW”. The topic “COP1” is stored corresponding to the author's name “Deng XW & von Arnim AG”.

In other words, the analysis-result integrating unit 260 integrates not only the information about the topic corresponding to the joint-author's name “Deng XW” but also the information about the topic corresponding to the joint-author group, which includes “Deng XW” as a joint-author's name, and displays the information integrated.

A screen, shown in FIG. 8B, displays the analysis result about the principal author “Deng XW” based on the time-series information. This integrated analysis-result screen displays the names of “Deng XW” at the top, and the names of the joint authors of “Deng XW” in descending the number of the collaboration documents with “Deng XW”. The number of the collaboration documents and the total number of the documents are tallied according to a predetermined number of publication years, and displayed with the name. The user, for example, can grasp the temporal transition of the topic of “Deng XW”'s research by combining the integrated analysis-result screen and the topic of the joint authors.

The screen, shown in FIG. 8B, displays the integrated analysis-result in case that the user specifies the author. The number of the documents about a certain topic according to a predetermined number of publication years can be displayed by the user's specifying the topic, therefore, the user can grasp the temporal transition of the topic.

An integrated analysis-result screen, shown in FIG. 8C, displays the names of the joint authors of the principal author “Deng XW” according to a predetermined number of years in descending the number of the collaboration documents. The numbers of the collaboration documents are displayed with the names. The user can grasp the author who has the collaboration document with the principal author according to a predetermined number of years using the integrated analysis-result screen.

A screen, shown in FIG. 8D, displays the number of the documents corresponding to the topic relevant to the principal author “Deng XW” according to a predetermined number of years. The user can grasp the topic of the documents of the principal author according to a predetermined number of years using the integrated analysis-result screen.

In this manner, the analysis-result integrating unit 260 integrates the analysis result, which is stored in the analysis-result DB 250 corresponding to each joint-author (each joint-author group), corresponding to each author or each topic, and displays the integrated analysis-result as the integrated analysis-result screen. Therefore, the user can grasp the analysis result corresponding to each joint-author (each joint-author group) from a macro viewpoint.

When the user inputs the information to the input-output unit 270, the input-output unit 270 passes the information to the controller 280. The input-output unit 270 outputs the images, which the generating unit 230 and the analysis-result integrating unit 260 display, to the display.

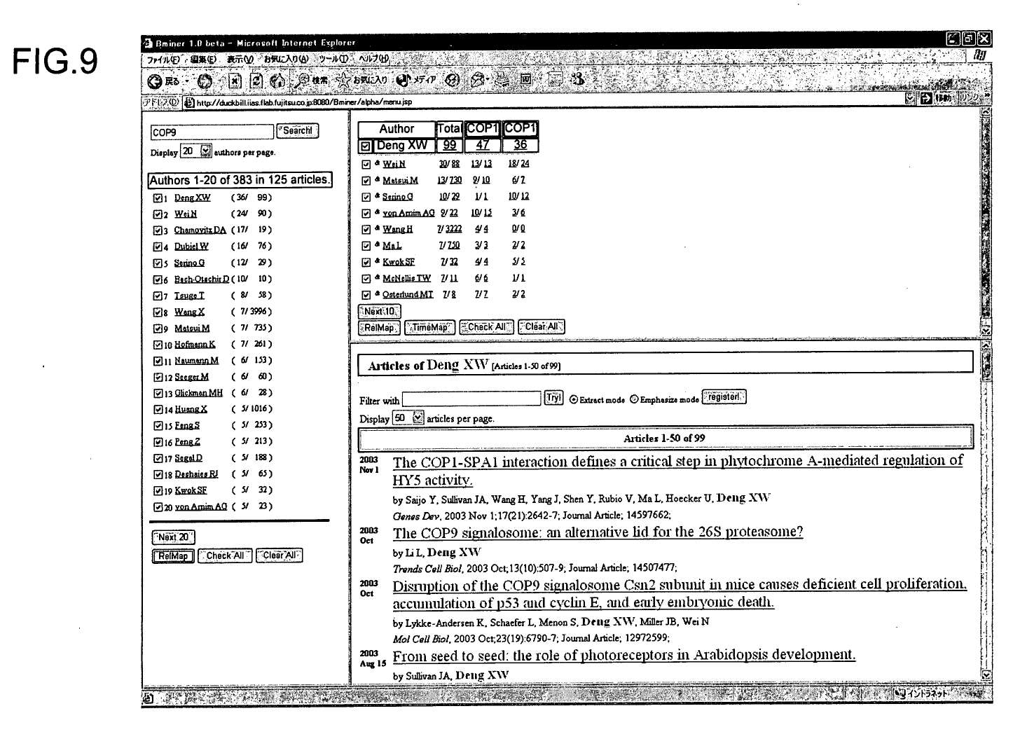

An example of the display screen that the input-output unit 270 outputs is shown in FIG. 9. As shown in FIG. 9, the display displays the screen, shown in FIG. 5, for selecting the target for the analysis, and the integrated analysis-result screen, shown in FIG. 8A, in multiwindow mode.

The controller 280 controls the document-analysis apparatus 200 entirely. The controller 280 transfers the control between the function units, and the data between the function unit and the memory, so that the document-analysis apparatus 200 functions as an apparatus.

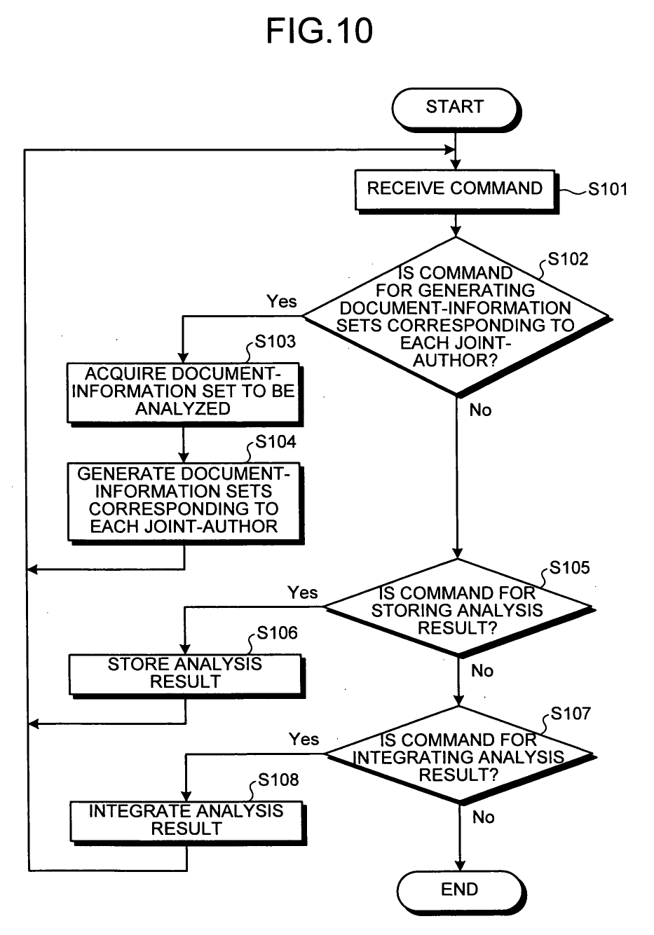

FIG. 10 is a flowchart of operations of the document-analysis apparatus 200. In the document-analysis apparatus 200, the input-output unit 270 receives the command from the user (step S101), and the controller 280 determines whether the command is for generating the document-information sets corresponding to each joint-author (step S102).

If the command is for generating the document-information sets corresponding to each joint-author, the document-retrieving unit 220 acquires the document-information sets to be analyzed from document DB 210 based on the user's command (step S103), and the generating unit 230 generates the document-information sets corresponding to each joint-author (step S104). The generating unit 230 displays the screen to support selecting the target for the analysis in response to the user's request. Then, the operations return to the step S101 to receive the next command.

If the command is not for generating the document-information sets corresponding to each joint-author, it is determined whether the command is for storing the analysis result (step S105). If the command is for storing the analysis result, the analysis-result storing unit 240 stores the result of analyzing the document-information sets corresponding to each joint-author in the analysis-result DB 250 (step S106). Then, the operations return to the step S101 to receive the next command.

If the command is not for storing the analysis result, it is determined whether the command is for integrating the analysis result (step S107). If the command is for integrating the analysis result, the analysis-result integrating unit 260 integrates the information about the analysis-result DB 250 based on the user's command, and displays the integrated analysis-result. Then, the operations return to the step S101 to receive the next command. If the command is not for integrating the analysis result, the operations end.

In this manner, the generating unit 230 generates the document-information sets corresponding to each joint-author, the analysis-result storing unit 240 stores the result of the user's analyzing document-information sets corresponding to each joint-author, and the analysis-result integrating unit 260 integrates the information about the analysis-result DB 250 based on the user's command. Consequently, the technology according to the present embodiment can supports the user's analyzing the documents.

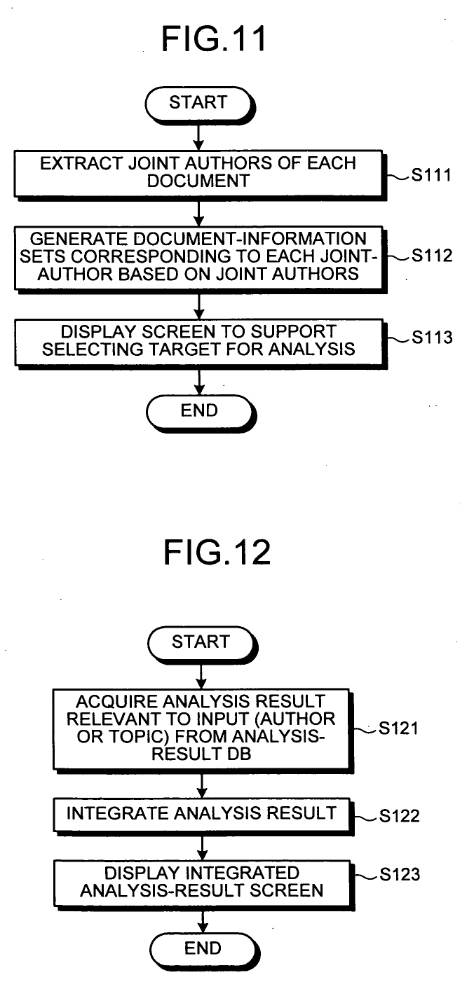

FIG. 11 is a flowchart of operations of the generating unit 230. The generating unit 230 extracts the joint authors of each document from the document-information set (step S111), and generates the document-information sets corresponding to each joint-author based on the joint authors extracted (step S112). Then, the generating unit 230 displays a screen specified by the user to support selecting the target for the analysis using the document-information sets generated (step S113).

In this manner, the generating unit 230 generates the document-information sets corresponding to each joint-author, and displays the screen specified by the user to support selecting the target for the analysis using the document-information sets generated corresponding to each joint-author. Consequently, the user can easily detect the document to preferentially analyze.

FIG. 12 is a flowchart of operations of the analysis-result integrating unit 260. The analysis-result integrating unit 260 acquires the analysis result about the author, which is input by the user or the topic input by the user, from the analysis-result DB 250 (step S121). Then, the analysis-result integrating unit 260 integrates the analysis result corresponding to each author or each topic (step S122), and displays the integrated analysis-result as the integrated analysis-result screen based on the user's specification.

In this manner, the analysis-result integrating unit 260 integrates the analysis result, which is stored in the analysis-result DB 250 corresponding to each joint-author (each joint-author group), corresponding to each author or each topic, and displays the integrated analysis-result as an integrated analysis-result screen. Consequently, the user can grasp the analysis results corresponding to each joint author (each joint-author group) from a macro view point, and detect the relevancy between the topics.

As described above, the generating unit 230 generates the document-information sets corresponding to each joint-author from the relevant-document information set, the analysis-result storing unit 240 stores the result of the user's analyzing the document-information sets corresponding to each joint-author in the analysis-result DB 250 as a topic, and the analysis-result integrating unit 260 integrates the joint-author's topics (the joint-author group's topics) stored in the analysis-result DB 250, and displays the integrated analysis-result. Consequently, the technology according to the present embodiment helps the user to understand the document contents and acquire the knowledge from the document set easily.

Moreover, appropriate screens are displayed to support selecting the target of the analysis using the document-information sets that the generating unit 230 generates corresponding to each joint-author. Consequently, the user can easily grasp the document to preferentially analyze.

Although the document-analysis apparatus 200 functions as a single apparatus in the present embodiment, the present invention is not to be thus limited. For example, the present invention may be applied to the document-analysis system that includes a terminal having a function of the input-output unit 270 and a document-analysis apparatus having a communication function instead of the input-output unit 270. In the above document-analysis system, the terminal and the document-analysis apparatus are connected via the network.

Although the document-analysis apparatus is explained in the present embodiment, the present invention may be applied to the document-analysis computer program that is configured to have the same function as the document-analysis apparatus.

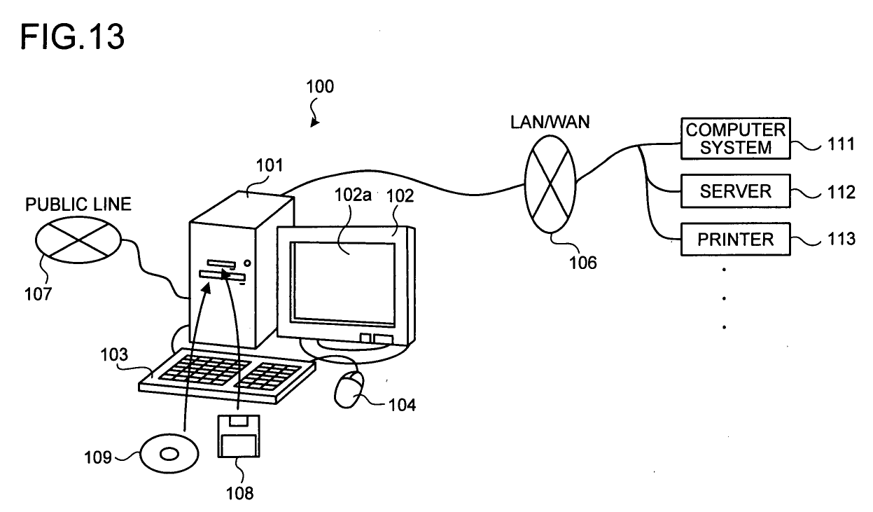

FIG. 13 is a schematic diagram of a computer system 100 that executes a document-analysis computer program according to the present embodiment. The computer system 100 includes a main unit 101, a display 102, which displays an image or the like on a screen 102a based on commands from the main unit 101, a keyboard 103, which is used to input various types of information to the computer system 100, a mouse 104, which is used to specify any points on the screen 102a, a Local Area Network (LAN) interface, which is connected to a Local Area Network/Wide Area Network (LAN/WAN) 106, and a modem, which connects the computer system 100 to a public line 107. A computer system 111, such as a Personal Computer (PC), a server 112, and a printer 113 are connected to the computer system 100 via the LAN/WAN 106.

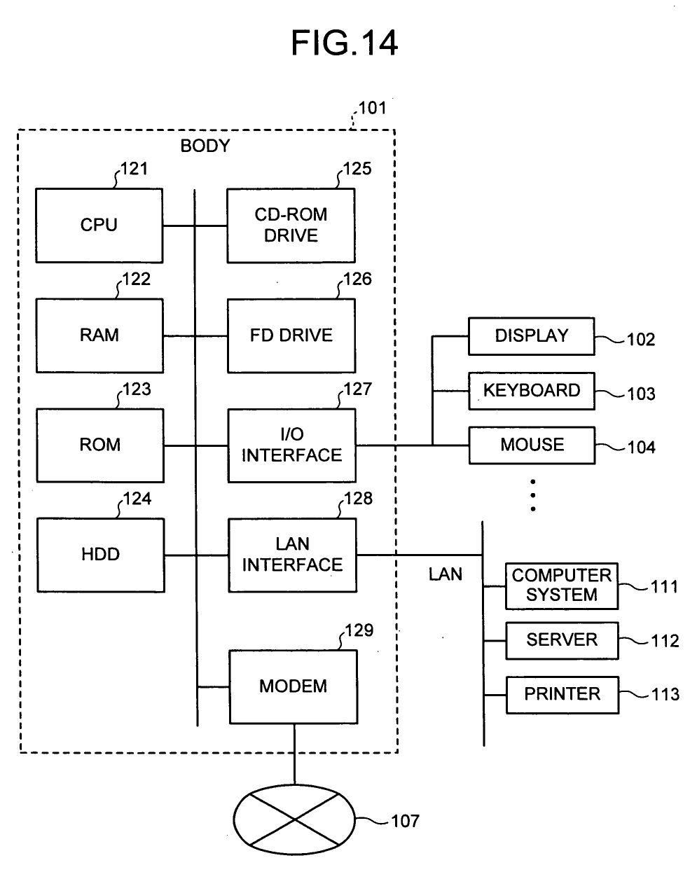

FIG. 14 is a block diagram of the main unit 101. The main unit 101 includes a Central Processing Unit (CPU) 121, a Random Access Memory (RAM) 122, a Read Only Memory (ROM) 123, a Hard Disk Drive (HDD) 124, a Compact-Disk Read-Only-Memory drive (CD-ROM drive) 125, a floppy disk (FD) drive 126, an Input/Output (I/O) interface 127, a LAN interface 128, and a modem 129.

The document-analysis computer program executed on the computer system 100 is stored in the portable storage-media, such as an FD 108, a CD-ROM 109, a Digital Versatile Disk (DVD), a Magneto-Optical disk, and an Integrated Circuit (I/C) card. The document-analysis computer program is read from the storage media and installed on the computer system 100.

Alternatively, the document-analysis computer program is stored in the database of the server 112, which is connected via the LAN interface 128, the database of the computer system 111 (such as a PC), or the like, read from the database, and installed on the computer system 100.

The document-analysis computer program installed is stored in the HDD 124, and executed by the CPU 121 while using the RAM 122 and the ROM 123.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer program for analyzing a first information-set, which is a set of information about a document relevant to a subject, making a computer execute:
generating second information-sets, which are sets of document information, from the first set corresponding to each of a plurality of joint authors; and
displaying information about the second information-sets.

2. The computer program according to claim 1, further making the computer execute:
storing an analysis result in storage media, the analysis result is obtained by analyzing the information about the second sets and specified by a user;
integrating the analysis result stored in the storage media and generating information about the analysis result integrated; and
displaying the information generated.

3. The computer program according to claim 2, wherein the storing includes
analyzing the information about the second set and generating analysis contents, and
storing the analysis result in the storage media by the user's analyzing the second information-set and referring to the analysis contents generated.

4. The computer program according to claim 1, wherein
the displaying includes displaying names of the joint authors and numbers of documents of each of the joint authors in descending order of number of collaboration documents.

5. The computer program according to claim 1, wherein
the displaying includes displaying numbers of documents of the joint authors of an author the user specifies in descending order of number of the collaboration documents written by at least the author and the joint author.

6. The computer program according to claim 1, wherein
the displaying includes illustrating a relation about the collaboration documents among the joint authors by indicating the joint author by node and the relation about the collaboration documents by line.

7. The computer program according to claim 2, wherein
the analysis result to be stored corresponds to a topic of a document whose information is included in the second information-set, and
the integrating includes generating number of documents of an author the user specifies and number of documents of the joint author as information of the analysis result integrated according to the topic is stored corresponding to a joint-author group that includes the author and the joint author.

8. The computer program according to claim 2, wherein
the analysis result to be stored corresponds to a topic of a document whose information is included in the second information-set, and
the integrating includes generating number of documents of an author and number of documents of the joint author as information of the analysis result integrated according to a predetermined number of years, and the topic the user specifies is stored corresponding to a joint-author group that includes the author and the joint author.

9. The computer program according to claim 2, wherein
the integrating includes generating number of documents of an author that the user specifies and number of documents of the joint author of the author as information of the analysis result integrated according to a predetermined number of years.

10. A computer program for analyzing a first information-set, which is a set of information about a relevant document, in response to a request from a terminal that a user operates, making a computer execute:
generating a second information-set, which is a set of document information, from the first set corresponding to each of plurality of joint authors;
generating data for displaying document information from information of the second set corresponding to each of the joint authors, the document information is displayed on the terminal using the data for displaying the document information; and
transmitting the data for displaying the document information to the terminal.

11. The computer program according to claim 10, further making the computer execute:
storing analysis result in storage media, and the analysis result is corresponding to each of the joint-authors, and specified by the user through an analysis of the information about the second set;
integrating the analysis result stored and generating information about the analysis result integrated;
generating data for displaying the analysis result integrated from the information about the analysis result integrated, and the information about the analysis result integrated is displayed on the terminal using the data for displaying the analysis result integrated; and
transmitting the data for displaying the analysis result integrated to the terminal.

12. A computer-readable recording medium for storing a computer program for analyzing a first information-set, which is a set of information about a document relevant to a subject, the computer program making a computer execute:
generating second information-sets, which are sets of document information, from the first set corresponding to each of a plurality of joint authors; and
displaying information about the second information-sets.

13. The computer-readable recording medium according to claim 12, wherein the computer program further making the computer execute:
storing an analysis result in storage media, the analysis result is obtained by analyzing the information about the second sets and specified by a user;
integrating the analysis result stored in the storage media and generating information about the analysis result integrated; and
displaying the information generated.

14. A computer-readable recording medium for storing a computer program for analyzing a first information-set, which is a set of information about a relevant document, in response to a request from a terminal that a user operates, the computer program making a computer execute:
generating a second information-set, which is a set of document information, from the first set corresponding to each of plurality of joint authors;
generating data for displaying document information from information of the second set corresponding to each of the joint authors, the document information is displayed on the terminal using the data for displaying the document information; and
transmitting the data for displaying the document information to the terminal.

15. A method of analyzing a first information-set, which is a set of information about a document relevant to a subject, comprising:
generating second information-sets, which are sets of document information, from the first set corresponding to each of a plurality of joint authors; and
displaying information about the second information-sets.

16. The method according to claim 15, further comprising:
storing an analysis result in storage media, the analysis result is obtained by analyzing the information about the second sets and specified by a user;
integrating the analysis result stored in the storage media and generating information about the analysis result integrated; and
displaying the information generated.

17. A method of analyzing a first information-set, which is a set of information about a relevant document, in response to a request from a terminal that a user operates, comprising:
generating a second information-set, which is a set of document information, from the first set corresponding to each of plurality of joint authors;
generating data for displaying document information from information of the second set corresponding to each of the joint authors, the document information is displayed on the terminal using the data for displaying the document information; and
transmitting the data for displaying the document information to the terminal.

18. A device for analyzing a first information-set, which is a set of information about a document relevant to a subject, comprising:
a generating unit that generates second information-sets, which are sets of document information, from the first set corresponding to each of a plurality of joint authors; and
a displaying unit that displays information about the second information-sets.

19. The device according to claim 18, further comprising:
a storing media to store an analysis result, the analysis result is obtained by analyzing the information about the second sets and specified by a user;
an integrating unit that integrates the analysis result stored in the storage media and generates information about the analysis result integrated; and
a displaying unit that displays the information generated.

20. A device for analyzing a first information-set, which is a set of information about a relevant document, in response to a request from a terminal that a user operates, comprising:
an integrating unit that generates a second information-set, which is a set of document information, from the first set corresponding to each of plurality of joint authors;
a generating unit that generates data for displaying document information from information of the second set corresponding to each of the joint authors, the document information is displayed on the terminal using the data for displaying the document information; and
a transmitting unit that transmits the data for displaying the document information to the terminal.
